(19) United States
(12) Patent Application Publication
(10) Pub. No.: US 2007/0207783 A1
(43) Pub. Date: Sep. 6, 2007

(54) SYSTEM FOR TUNING AN FM TRANSMITTER USING THE DIALING PAD OF A CELLULAR TELEPHONE

(76) Inventors: Li Da Ye, Guangdong (CN); Noah Amit, Haifa (IL); Yonathan Amit, Omer (IL)

Correspondence Address: SMITH FROHWEIN TEMPEL GREENLEE BLAHA, LLC, Two Ravinia Drive, Suite 700, ATLANTA, GA, 30346, US

(21) Appl. No.: 11/466,452

(22) Filed: Aug. 22, 2006

Related U.S. Application Data
(60) Provisional application No. 60/712,015, filed on Aug. 29, 2005.

(51) Int. Cl. H04Q 7/38; H04Q 7/22; H04M 3/42

(52) U.S. Cl. 455/414.1

(57) ABSTRACT

Audio signals generated by one device, such as a cellular telephone, an MP-3 device, a CD player or the like are transmitted to an RF receiver to be amplified and presented audibly. An RF transmitter is coupled to the device to receive the audio signals and also to a frequency selection interface. The frequency selection interface may be a menu driven interface, a keypad, hardware equipment for automatically selecting a frequency, or the like. The selected frequency is used to tune the RF transmitter and a user is informed as to what frequency the audio signals are available for listening.

### CROSS-REFERENCE TO RELATED APPLICATIONS

This patent application is a U.S. nonprovisional application filed pursuant to Title 35, United States Code § 100 et seq. and 37 C.F.R. Section 1.53(b) claiming priority under Title 35, United States Code § 119(e) to U.S. provisional application No. 60/712,015 filed Aug. 29, 2005.

### BACKGROUND OF THE INVENTION

Every now and then, one of us humans says “E-N-O-U-G-H!”, packs up his or her family, moves to a new location, changes occupations, or takes other actions to simplify their lives and, most important of all, shorten their commute time. Meanwhile, the rest of the human race looks on admiringly, and somewhat quizzically, as they climb into their cars ready for another 45 minute to 2 hour commute—depending on traffic. Yes, us humans tend to clump together and as a result, it takes longer and longer to get where we want to go. And as people are spending more and more time in the car, the consumer product market is trying to capitalize on the desire to be entertained or productive during those long commutes. Unfortunately, the concept of being entertained or productive while driving is diametrically opposed to our personal safety, as well as the safety for those sharing the road.

One of the many consumer products that is rapidly gaining popularity amongst the hoards of commuters is the MP-3 player devices. With the increasing demand for MP-3 devices, coupled to the fact that we should always keep at least one hand on the wheel, cellular telephone companies are jumping on the band wagon. Many cellular telephones now come fully equipped with state-of-the-art MP-3 players, with the ability to download music over the air and load music from memory cards. However, because of the competing demands of keeping cellular telephones small and light, such embedded MP-3 players typically do not include amplification technology and as such, are only usable with ear phones. Such operation may be fine for the user sitting at his or her desk, walking down the road or riding on a mass transient system. However, for the driver of an automobile, the use of ear phones or head phones can create several safety hazards. First of all, the ear buds can restrict the driver's ability to hear the traffic around him and, the cord can become tangled creating a distraction to the driver. However, right there in arms reach to the driver is typically an in-dash stereo system. It is quite desirable to have the ability for an MP-3 player, either a stand alone unit or one embedded within another device, such as a cellular telephone, to reap the benefit of the amplification and sound delivery of the in-dash stereo system.

Similarly, while utilizing an MP-3 player device in the home or other setting that may have a stereo system or amplification system at bay, it is quite desirable to utilize such systems for the playback of the MP-3 content.

Several techniques have been introduced to the market in an effort to address this issue. One technique that has gained wide popularity in the automotive and motor vehicle environment is the head phone jack to cassette tape head adapter. This device includes a jack that mates with a standard head phone receptacle on a player device, and a wire that terminates in a cassette like adapter. In operation, the user simply inserts the head phone jack into the player device and the cassette like adapter into the slot on the cassette player. The audio signals from the player device are then fed into the stereo system through the head of the cassette deck. This technique is an inadequate solution in that the connection is prone to being lossy and subject to noise, as well as requiring a wire to run between the player and the cassette deck. What is desired is a wireless solution that enables the user to retain mobility with the player device, and that does not include the restrictions and potential safety hazards associated with the wired connection.

Another technique that has been introduced to the market is the FM transmitter. Companies like APPLE, have developed custom products that mate with the IPOD players and generate and FM signal containing the currently playing content of the player device. This FM signal can then be picked up by the FM antenna of a car stereo or other stereo system and played back through the sound system. This technique is an inadequate solution in that the devices are player device specific and are not adaptable for use with general devices.

What is needed in the art is a solution that enables any player device to be wireless coupled to a stereo system for the playback of content, such as MP-3 content, as well as any other type of content, such as voice for a cellular telephone. Such a solution would advantageously improve the safety of operating such playback device within an automotive vehicle and would not unnecessarily restrict the mobility of a user during playback in other environments.

### BRIEF SUMMARY OF THE INVENTION

In general, the present invention is directed towards an apparatus and a method that enables audio signals, generated by a device, such as a portable, handheld MP-3 player, cellular telephone, etc., to be transmitted over a preferred frequency to a receiver that then amplifies and renders the audio signals. One embodiment of the invention includes and apparatus to enable the transmission of audio signals to a radio receiver for audible playback. The apparatus includes a radio frequency transmitter that is tunable over a range of frequencies. The apparatus includes an audio signal interface that receives audio signals and delivers the audio signals to the radio frequency transmitter. The apparatus also includes a frequency selection interface that receives signals identifying one of a plurality of frequencies at which to tune the radio frequency transmitter. Finally, the apparatus includes a controller operable to tune the radio frequency transmitter based on the signals received on the frequency selection interface and to enable the radio frequency transmitter to transmit the received audio signals at the tuned radio frequency. The apparatus may be a stand alone device that is coupled to another device that generates audio signals, or it may be embedded with such a device. For instance, the apparatus may interface to the audio output jack and serial port of a cellular telephone, or it may be integrated into the handset of a cellular telephone. Likewise, the apparatus can be connected to external connections of an MP-3 player or it can be integrated into the MP-3 player. In the stand-alone embodiments, the audio interface is a standard headphone or ear plug jack, such as the 3.5 mm jack or even the ¼ inch jacks.

In one embodiment of the present invention, the RF transmitter is an FM transmitter suitable for transmitting frequencies receivable by any typical FM radio receiver. However, in other embodiments, the RF transmitter may be in other frequency ranges including, but not limited to the AM, HF, VHF, UHF, LF, VLF, ULF, 900 MHz and unlicensed frequency ranges, as well as other frequency ranges and combinations of two or more of these ranges.

The frequency selection can be determined in a variety of manners including directly entering the frequency, or a representative code for a frequency, using a dial keypad, such as the cellular telephone handset keypad. In this embodiment, the frequency can be identified by detecting DTMF key sequences or by recovering serial commands from the serial port of the cellular telephone. In a specific embodiment of the present invention, the frequency is entered by dialing a special sequence, that includes either a prefix or a suffix to identify the sequence as a frequency selection, and a sequence that identifies the specific frequency. In addition, the frequency or one or more frequencies may be identified using other techniques, and then displayed to a user prompting him or her to select a frequency. The other techniques for identifying these frequencies can be performed in a variety of manners including a frequency analyzer that can detect and identify energy at various frequencies, or from some other independent process or device.

### BRIEF DESCRIPTION OF THE SEVERAL VIEWS OF THE DRAWING

FIG. 1 is a block diagram illustrating an exemplary embodiment of the present invention suitable for operation with a cellular telephone.

FIG. 2 is a block diagram of another embodiment of the present invention.

FIG. 3 is a schematic diagram illustrating one specific example of an embodiment of the present invention but is presented as a non-limiting example.

FIG. 4 is a flow diagram illustrating the steps involved in an exemplary embodiment of the present invention.

### DETAILED DESCRIPTION OF THE INVENTION

The present invention provides the ability for any playback device to transmit a signal to any radio or music system for the playback of content without requiring any physical connections. For example, the present invention enables a cellular telephone that includes and embedded MP-3 player to playback audio content, such as voice and MP-3 content, through an in-dash car stereo system. As another example, the present invention enables a cellular telephone conversation to be played through a home stereo system such as a speaker phone.

More specifically, a user with an MP-3 player, including but not limited to an MP-3 player embedded within in a cellular telephone, can first identify a relatively available or unused FM frequency. This task can be accomplished in a variety of manners. For instance, a user can use a spectrum analyzer to find a frequency with low signal energy. However, more typically a user can tune an FM receiver to a channel that does not include any audible station signals. Once the relatively available frequency is identified, the user can instruct the MP-3 player to transmit on that frequency through a user interface. For a cellular telephone embodiment of the present invention, the user can select the frequency by tuning of an FM transmitter in the device to the specific frequency by dialing the frequency, or a code for the frequency, on the cellular telephone key pad. In one embodiment of the present invention, a special prefix or suffix may be used to identify the entered digits as an FM frequency. For example, the user may dial “**918” to cause the FM transmitter to tune to the frequency of 91.8 Mhz.

It will be appreciated that the transmitter used by the various embodiments of the present invention can be based on a variety of technologies. For instance, the use of an FM transmitter has been described but, those skilled in the art will appreciate that an AM transmitter, or a variety of other RF transmitters could be used, as well as any multi-channel frequency system. It will also be appreciate that the present invention can be utilized to provide stereo sound, mono sound, quadrature or any of a variety of sound qualities. It will also be appreciated that the present invention can be used to select any number of channels, only limited by the choice of transmission technologies and the range and granularity of the selected amplifier.

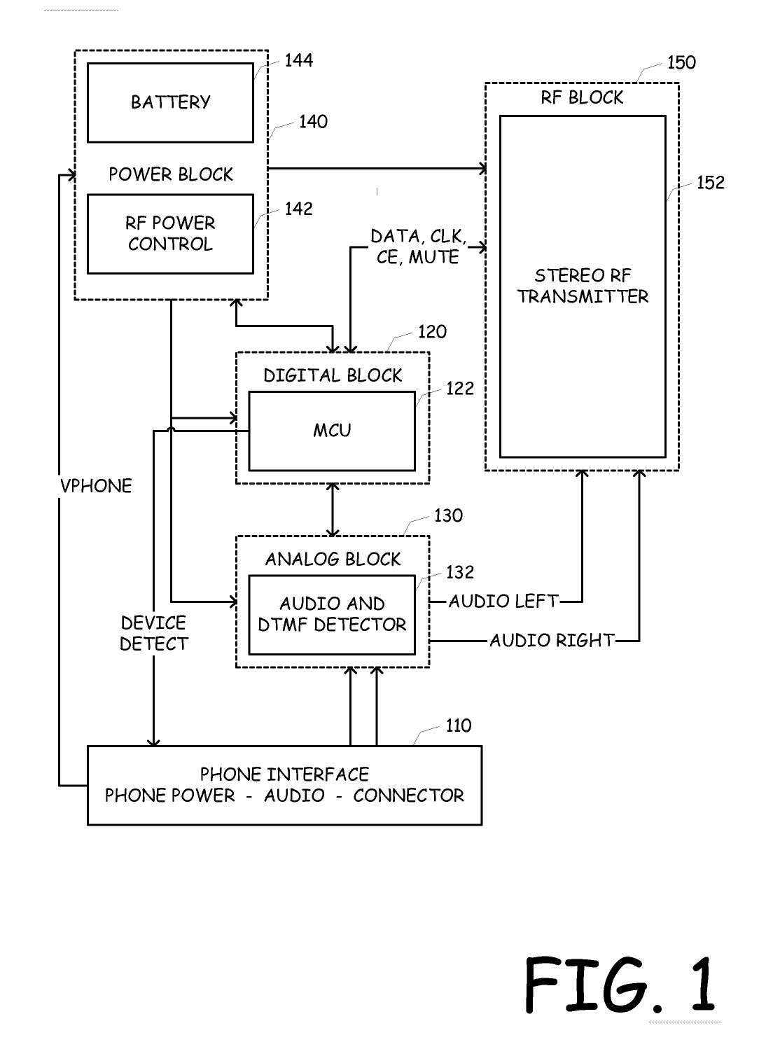

FIG. 1 is a block diagram illustrating an exemplary embodiment of the present invention suitable for operation with a cellular telephone. A phone interface 110 is shown as providing the main interface to the standard telephone, including the power, audio and control signaling of the cellular telephone. It should be appreciated that the illustrated embodiment may be incorporated directly into the cellular handset, such as being integrated into the circuitry of the cellular handset, or it may be a separate device that plugs into a port of a cellular handset. And although either embodiment may in and of itself be considered novel, aspects of the present invention are not limited to any particular embodiment. The illustrated embodiment further includes (a) digital circuitry 120 that amongst other things, includes a micro-controller unit MCU 122; (b) analog circuitry 130 that among other things, includes audio and DTMF detectors 132; (c) power circuitry 140 that includes RF power control 142, and optionally a battery 144 or an interface to DC power or and AC to DC converter (not shown); and (d) radio frequency or RF circuitry 150 that includes a stereo RF transmitter 152.

In the illustrated embodiment, the present invention operates by interfacing to the cellular telephone circuitry to receive tuning commands for the stereo RF transmitter and to then route the audio signals to the RF transmitter to be broadcast to a nearby receiver. More specifically, the power circuitry 140 provides power to the other illustrated components. However, it should be appreciated that the same power used to power the cellular telephone may be used to power the illustrated circuitry in a fully embedded embodiment. Thus, VPHONE may be fed to the power circuitry 140 from the interface to the cellular telephone 110. The MCU 122 may use a device detect interface to identify when the circuitry is connected to a cellular telephone or, in a fully embedded embodiment, to determine when the cellular telephone is in a state that could benefit from the use of the illustrated circuitry. For instance, if the cellular telephone is in standby mode with no voice audio being received or no audio being generated, the illustrated circuitry can use the DEVICE DETECT signal to indicate this case and thus, shut down aspects of the circuitry thereby conserving battery power.

The MCU 122 also interfaces to the analog circuitry 130, and more specifically to the audio and DTMF detector. Through this interface, the MCU 122 can detect when operations are being performed with the cellular telephone and take actions accordingly. Thus, if the cellular telephone is used to identify a desired frequency for the transmission of audio signals, the MCU 122 can detect control signals or operations of the cellular telephone that would identify the desired frequency. As a specific, non-limiting example, the MCU 122 can detect when keys of the cellular telephone keypad are being depressed in certain cellular telephone states by detecting the presence of DTMF tones on the cellular telephone interface. By monitoring the DTMF tones, the MCU 122 can detect the dialing of a special sequence that indicates a desired frequency to which the stereo RF transmitter 152 should be tuned. Thus, if the predefined sequence to select a frequency is two asterisks followed by a four digit frequency code, the MCU 122 watches for the presence of two asterisks being dialed, and then captures the next for digits to identity the desired frequency.

It should be appreciated that the described embodiment is only one exemplary embodiment of this aspect of the present invention. For instance, rather than detecting DTMF tones, the present invention may operate to detect control signals generated by pressing buttons on the cellular telephone. In addition, dialed memory storage locations within the cellular telephone can be used to store pre-selected frequencies. In this embodiment of the present invention, simply recalling the contents of those memory locations may trigger the identification of the desired frequency by the MCU 122. Those skilled in the art will appreciate that although the described embodiments may in and of themselves be novel, the present invention is not limited only to these embodiments.

It should be appreciated that the frequency may be provided to the MCU 122 in a variety of manners. As described above, the frequency may simply be a four digit entry that corresponds directly with the FM frequency desired (i.e. 104.7 FM could be identified as 1047). Other techniques include defaulting to a mid range frequency and allowing the user to increase or decrease the frequency by entering or pressing certain keys on the keypad of the cellular telephone. In other embodiments, specific frequencies may already be identified and the user simply scrolls through them until arriving at the desired frequency. Those skilled in the art will be able to identify other techniques and the present invention is not limited to any particular technique.

Once the desired frequency is selected and identified to the MCU 122, the MCU 122 interfaces to the stereo RF transmitter to load the synthesizer with the desired frequency and initiate the transmission of the audio signals. The audio signals may be obtained directly from the cellular telephone audio, or audio signals generated by and MP-3 player embedded within the cellular telephone.

It will also be appreciated that an embodiment of the present invention may exist totally external to the cellular telephone and interface to the cellular telephone through a data and/or RF and/or audio connector to the cellular telephone. Thus, in such an embodiment the desired frequency may be entered by pressing certain keys on the key pad of the cellular telephone and detecting serial control commands generated as a result of the key presses. In addition, this embodiment of the present invention may also interface to an audio device, such as an MP3 player through a standard audio connection. Thus, this embodiment of the present invention provides a universal stand-alone device that interfaces to a cellular telephone for identifying a selected transmission frequency and to an audio device for obtaining an audio feed to transmit to a local receiver and the selected frequency.

In another embodiment of the present invention, the MCU 122 may interface with a cellular telephone through a digital data interface and operate to request dialed calls notifications. When a dialed call with special prefix detected, the MCU 122 can send signals to the cellular telephone to abort the call as the dialed number in actuality is to be used for frequency adjustments.

Another embodiment of the present invention works directly with an audio device that includes a user interface. In this embodiment of the invention, the user interface of the audio device allows the user to enter a desired frequency, which is then fed directly to the circuitry for tuning the RF transmitter.

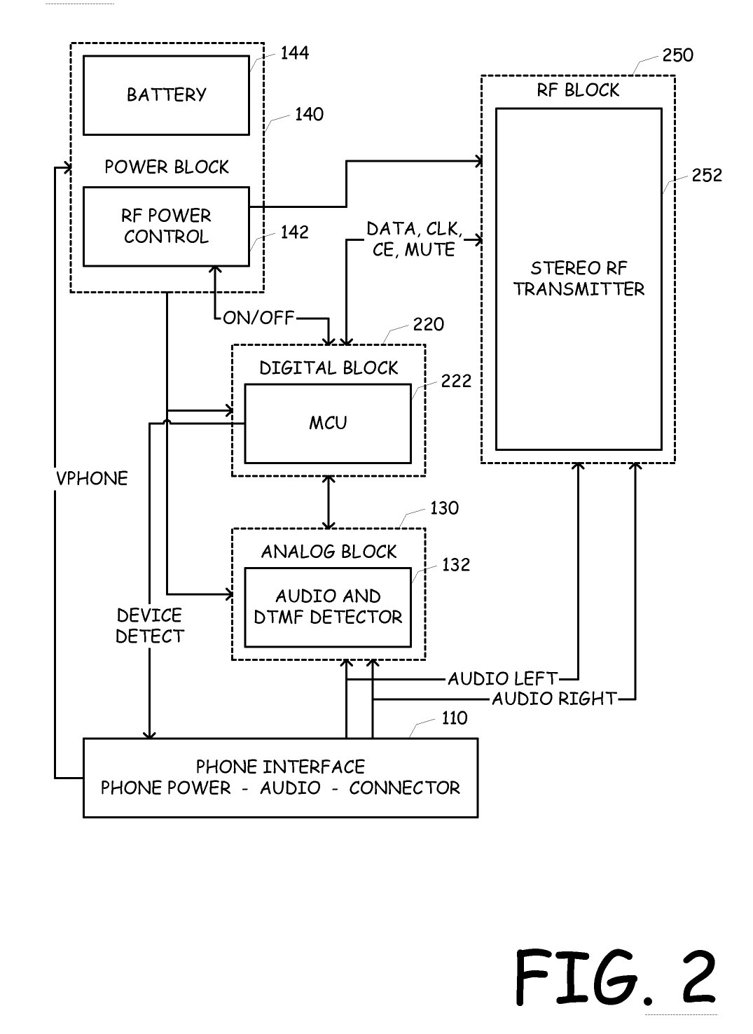

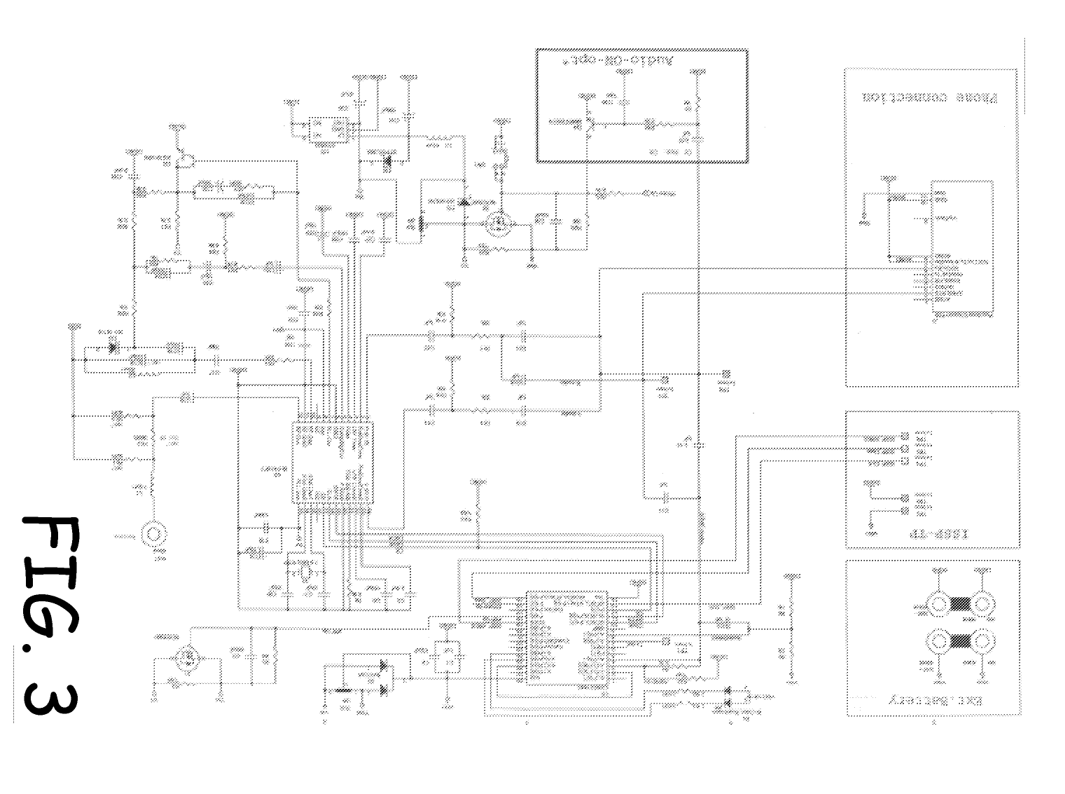

FIG. 2 is a block diagram of another embodiment of the present invention. In this embodiment of the invention, the left and right audio signal are fed directly into the stereo RF transmitter 250 from the cellular telephone or other audio device. The MCU 222 then operates to detect a frequency selection and then programs the transmitter accordingly. Finally, in this embodiment of the invention, the MCU 222 turns the stereo RF transmitter on and off depending on the state of the audio device. For instance, if an MP-3 file is being played on the cellular telephone device, the MCU 222 can detect this state and turn on the stereo RF transmitter. However, if a call comes into the cellular telephone, the MCU 222 can detect this and then turn off the stereo transmitter 250 to preserve the privacy of the telephone call.

It should be appreciated that as mentioned above, the present invention can be fully embedded or integrated into a device, such as a cellular telephone, PDA, MP-3 player, etc. or the present invention can be embodied in an adapter. In the former embodiments, it will be appreciated that the MCU illustrated in FIGS. 1 and 2 could be a separate processor or it could utilize the services of a processor, ASIC or other processing component already resident in the host device.

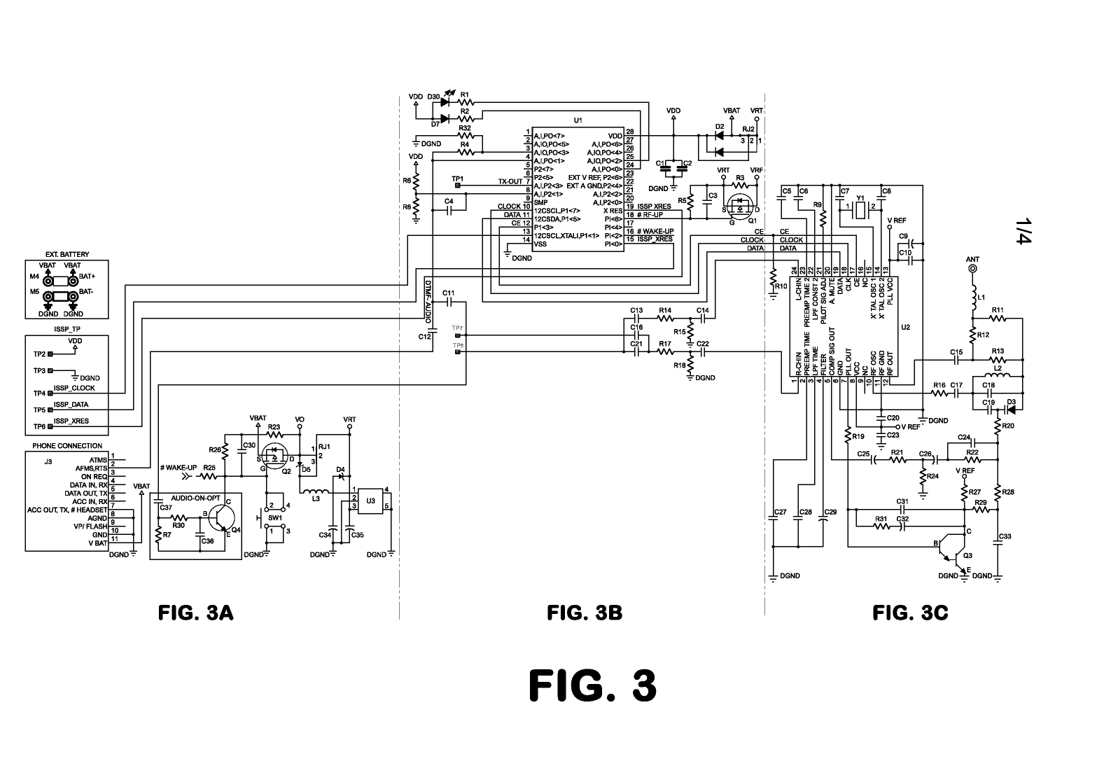

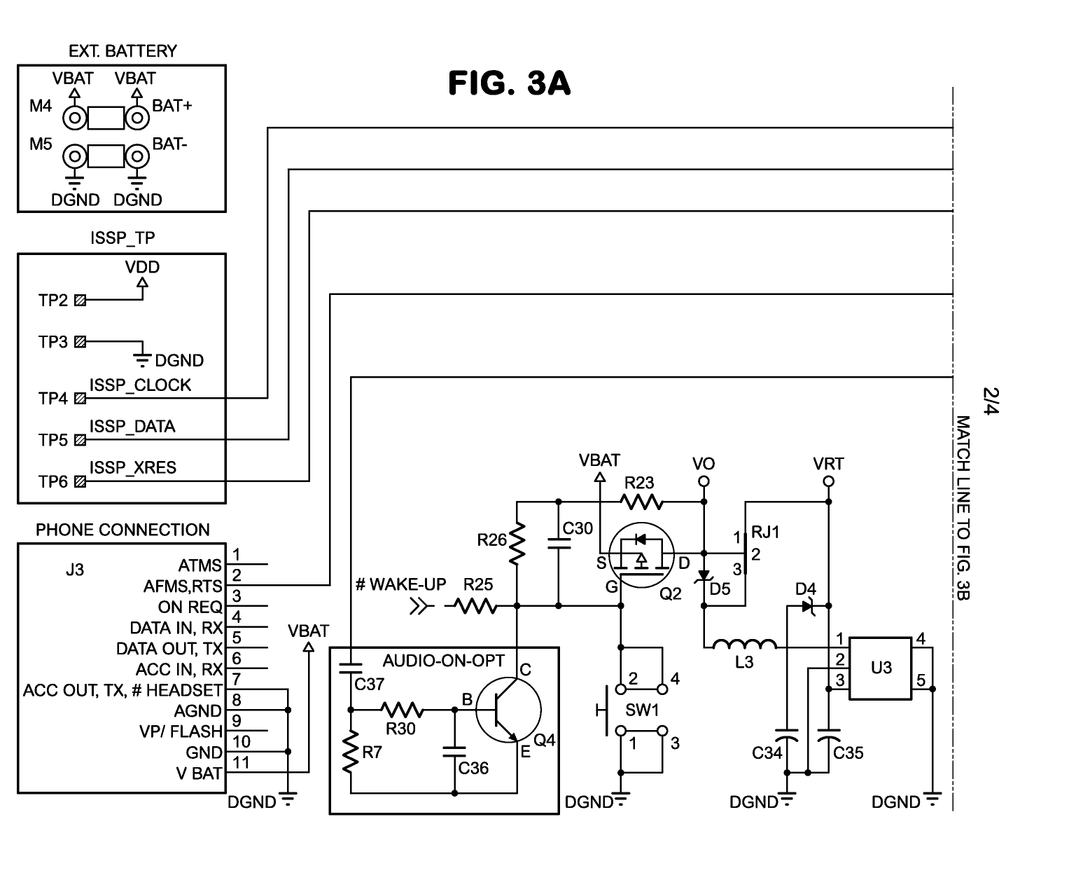

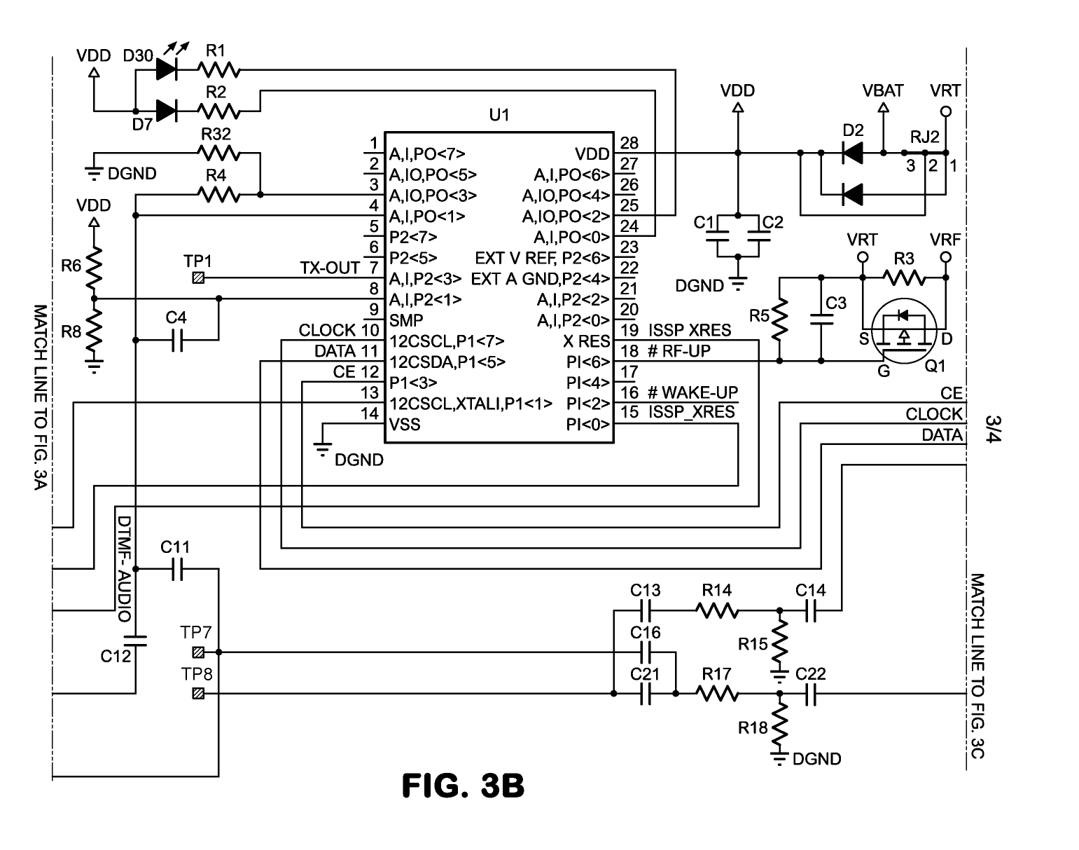

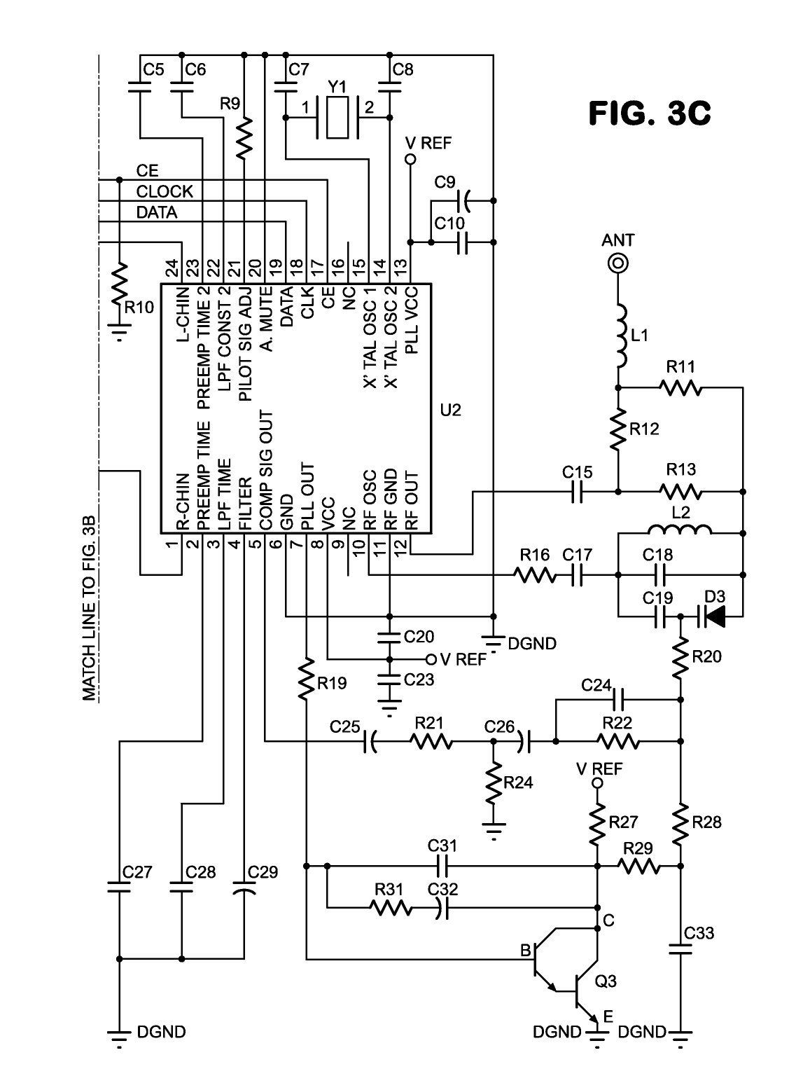

FIG. 3 is a schematic diagram illustrating one specific example of an embodiment of the present invention and is presented as a non-limiting example.

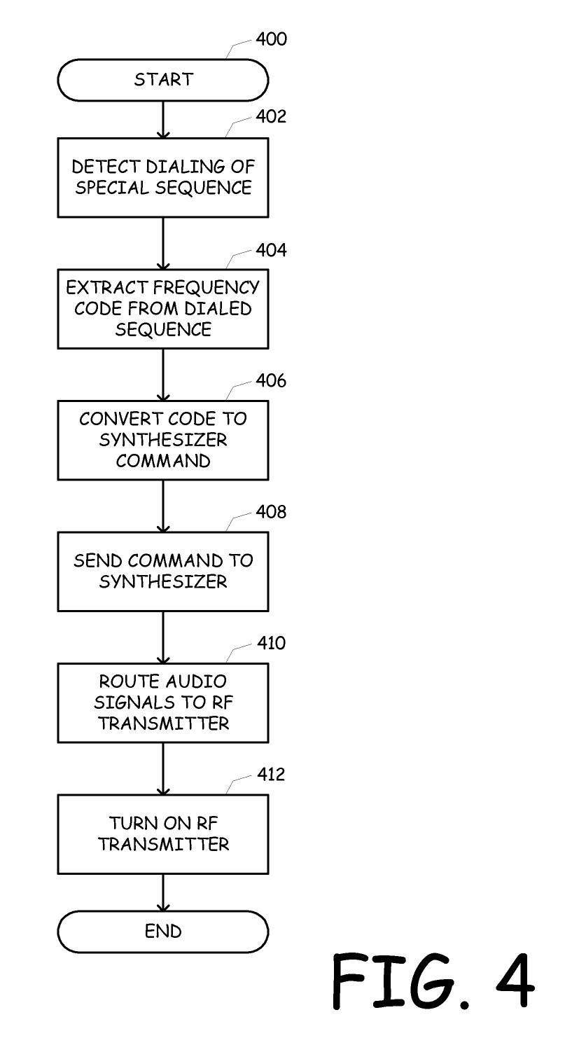

FIG. 4 is a flow diagram illustrating the steps involved in an exemplary embodiment of the present invention. The process 400 is initiated upon detecting the dialing of a special sequence 402. In the above-provided example, this special sequence was defined as two asterisks followed by a four digit frequency code (i.e. **1047). However, it will be appreciated that a variety of techniques could be used in a cellular telephone embodiment to provide this functionality. For instance, the cellular telephone user interface software may provide a menu interface to allow the user to select a specific frequency or place the cellular telephone into a programming mode to accept a particular frequency. It will also be appreciated that the cellular telephone may include a frequency analyzer that can search for the presence of energy and the absence of energy at various frequencies and automatically select an available frequency. In this embodiment the selected frequency may be displayed on the LCD of the cellular telephone to instruct the user to which channel to tune his or her receiver. This can be accomplished periodically, or every time the user turns on the cellular telephone, thus the present frequency is maintained as the best frequency for transmitting the signal. Each time the singal changes, whether only upon power up or periodically while power is applied, the user can be notified, either audibly or visible or both, of the new frequency. In addition, in some embodiments the user may select how often, if at all, that the phone searches for new frequencies.

Similarly, the frequency analyzer equipped cellular telephone can search for the presence of energy and the absence of energy at various frequencies and then display a list of one or more frequencies or channels from which the user can select. Those skilled in the art will appreciate that many user interfaces could be defined and implemented for entering or selecting the transmitting frequency for the audio data and although some of the described embodiments may be considered novel, they should not be construed to limit the general scope of the present invention.

Once the special sequence is detected, the frequency code is extracted from the sequence 404 and then converted into a command or a string sequence that can be loaded into the synthesizer of the RF transmitter 406. The command is then sent to the synthesizer to tune the synthesizer to the desired frequency 408. At this point any audio signals can be routed to the RF transmitter 410. The RF transmitter may be in an on state at this point or it may need to be turned on to enable the audio presentment 412. In addition, the audio can be muted by turning the RF transmitter off.

In the description and claims of the present application, each of the verbs, “comprise”, “include” and “have”, and conjugates thereof, are used to indicate that the object or objects of the verb are not necessarily a complete listing of members, components, elements, or parts of the subject or subjects of the verb.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons of the art

It will be appreciated by persons skilled in the art that the present invention is not limited by what has been particularly shown and described herein above. Rather the scope of the invention is defined by the claims that follow.

What is claimed is:

1. An apparatus to enable the transmission of audio signals to a radio receiver for audible playback, the apparatus comprising:
a radio frequency transmitter that is tunable over a range of frequencies;
an audio signal interface that receives audio signals and delivers the audio signals to the radio frequency transmitter;
a frequency selection interface that receives signals identifying one of a plurality of frequencies at which to tune the radio frequency transmitter; and
a controller operable to tune the radio frequency transmitter based on the signals received on the frequency selection interface and to enable the radio frequency transmitter to transmit the received audio signals at the tuned radio frequency.

2. The apparatus of claim 1, wherein the radio frequency transmitter is an FM transmitter.

3. The apparatus of claim 1, wherein the audio signal interface is a headphone jack that can be attached to the headphone audio output of a media playback device.

4. The apparatus of claim 3, wherein the headphone jack is a standard 3.5 mm jack.

5. The apparatus of claim 1, wherein the frequency selection interface is the keypad of a cellular telephone and the signals identifying one of a plurality of frequencies are signals representing various key presses.

6. The apparatus of claim 5, wherein the signals representing various key presses are DTMF signals available on the audio output of the cellular telephone.

7. The apparatus of claim 5, wherein the signals representing various key presses are available at a serial port of the cellular telephone.

8. The apparatus of claim 5, wherein the frequency selection interface is the keypad of a cellular telephone and the signals identifying one of a plurality of frequencies are generated by pressing a series of keys on the keypad, at least a portion of the series including a predefined sequence that indicates a frequency is being selected.

9. The apparatus of claim 1, wherein the apparatus is embedded within a cellular telephone and the audio signal interface is coupled to the audio signals lines within the cellular telephone and the frequency selection interface is coupled to the dialing mechanism of the cellular telephone.

10. The apparatus of claim 1, wherein the frequency selection interface is coupled to a frequency analyzer that can tune to a variety of frequencies and select a frequency that has the least amount of energy present and the signals identifying one of a plurality of frequencies identify the selected frequency.

11. The apparatus of claim 10, further comprising a display interface wherein the identification of the selected frequency can be displayed.

12. The apparatus of claim 1, wherein the frequency selection interface is coupled to a frequency analyzer that can tune to a variety of frequencies and select one or more frequencies that have energy below a threshold level.

13. The apparatus of claim 12, further comprising a display interface wherein the identification of the selected frequencies can be displayed and the signals identifying one of a plurality of frequencies is generated by a user selecting one of the displayed frequencies.

14. A method for providing audio signals from a cellular telephone to an RF receiver for the audio playback of audio content, the method comprising the steps of:
detecting a dialing sequence on the keypad of the cellular telephone;
parsing the dialed sequence to identify a special sequence indicating the input of a frequency selection;
extracting a frequency code from the dialed sequence;
tuning an RF transmitter based on the extracted frequency code; and
transmitting the audio signals from the RF transmitter at the tuned frequency.

15. The method of claim 14, further comprising the step of converting the frequency code to a synthesizer command and the step of tuning the RF transmitter further comprises sending the synthesizer command to the synthesizer of the RF transmitter.

16. The method of claim 14, wherein the step of transmitting the audio signals further comprises transmitting audio signals generated during a telephone conversation.

17. The method of claim 14, wherein the cellular telephone includes a digital music player and the step of transmitting the audio signals further comprises transmitting audio signals generated by the digital music player.

18. The method of claim 14, wherein the step of detecting a dialing sequence further comprises detecting DTMF tones on the audio lines of the cellular telephone.

19. The method of claim 14, wherein the step of detecting a dialing sequence further comprises detecting serial commands on the serial port of the cellular telephone.

20. An apparatus to enable the transmission of audio signals to a radio receiver for audible playback, the apparatus comprising:
a radio frequency transmitter that is tunable over a range of FM frequencies;
a stereo audio signal interface that receives stereo audio signals and delivers the stereo audio signals to the radio frequency transmitter;
a frequency selection interface that receives signals generated by a user selection and identifying one of a plurality of frequencies at which to tune the radio frequency transmitter; and
a controller operable to tune the radio frequency transmitter based on the signals received on the frequency selection interface and to enable the radio frequency transmitter to transmit the received audio signals at the tuned radio frequency.
